(19) United States
(12) Patent Application Publication
(10) Pub. No.: US 2015/0170821 A1
(43) Pub. Date: Jun. 18, 2015

(54) TRANSFORMER

(71) Applicant: ABB TECHNOLOGY AG, Zurich (CH)

(72) Inventors: Frank Cornelius, Olsberg (DE); Jiahua Zhang, Brilon (DE); Benjamin Weber, Winterberg (DE); Martin Carlen, Niederrohrdorf (CH); Thorsten Steinmetz, Baden-Dattwill (CH)

(73) Assignee: ABB TECHNOLOGY AB, Zurich (CH)

(21) Appl. No.: 14/632,400

(22) Filed: Feb. 26, 2015

Related U.S. Application Data
(63) Continuation of application No. PCT/EP2013/002451, filed on Aug. 14, 2013.

(30) Foreign Application Priority Data
Sep. 12, 2012 (EP) 12006409.2

(51) Int. Cl. H01F 27/24; H01F 27/29; H01F 27/32; H01F 27/28

(52) U.S. Cl. CPC H01F 27/24; H01F 27/2847; H01F 27/29; H01F 27/324

(57) ABSTRACT

An exemplary transformer includes a transformer core having at least one core limb, a main winding arranged around a respective core limb in a hollow-cylinder-like winding region, and an auxiliary winding, which is electrically connected to the main winding and is arranged close to the core. The cross-section of at least one of the core limb and a core yoke formed of the transformer core has in a cross-sectional plane transverse to an extent of said core limb or said core yoke, at least two regions which are separated by an aperture, and at least one turn of the respective auxiliary winding is passed through the aperture.

### RELATED APPLICATION(S)

This application claims priority under 35 U.S.C. §120 to International application PCT/EP2013/002451 filed Aug. 14, 2013, designating the U.S., and claiming priority to European application 12006409.2 filed on Sep. 12, 2012 in Europe. The content of each prior application is hereby incorporated by reference in its entirety.

### FIELD

The disclosure relates to a transformer, including a transformer core having at least one core limb and a main winding, which is arranged around the respective core limb in a hollow-cylinder-like winding region, and an auxiliary winding, which is electrically connected to the main winding and is arranged close to the core.

### BACKGROUND INFORMATION

Known transformers are used in electrical energy distribution networks for coupling power supply units of different voltage levels to one another. Such transformers are often implemented as dry-type transformers at a voltage level which is close to that of the consumer or that of the generating unit and have, for example, rated voltages in the range of from 1 kV to 6 kV on the low-voltage side and rated voltages in the range of from 10 kV to 30 kV on the high-voltage side, wherein corresponding rated powers are in the range of from 0.5 MVA to 10 MVA, for example. However, such transformers are also used in the sector of wind turbines, in which case the rated power of a transformer is dependent on the power of an associated wind turbine. Owing to the high rated currents in the low-voltage range, which can be a few 100 A, for example, the low-voltage windings are often designed to be wound from a ribbon conductor, wherein the width of a ribbon conductor usually corresponds to the total axial length of respective transformer windings. Depending on the exemplary arrangement and specifications in respect of the transformer, the number of turns on the low-voltage side is in the region of ten turns, for example, even in the case of applications for wind turbines in which the voltage generated on the generator side is correspondingly low and should be stepped up to a higher working level by the transformer.

For regulation purposes, it is a known procedure to provide the high-voltage-side winding(s) of a transformer with a plurality of taps, which are selectable by a respective on-load tap changer, for example, with the result that the transformation ratio from the transformer is therefore variable within a control range. Increased controllability is specified in the case of applications for wind turbines in order to ensure matching of the transformer to the boundary conditions resulting from different wind conditions.

The active component of a transformer has a closed iron core and at least one high-voltage winding and low-voltage winding with integral, closed turns around the respective core limb. The induced voltage per closed conductor loop is dependent on the line frequency, the flux density, and the core cross-section.

Issues with the known transformer include the on-load tap changer being arranged on the high-voltage side being very complex to manufacture, which owes to the high voltage loading, and the regulation of the voltage having a capacity to take place at a minimum tap change which corresponds to the induced voltage of a complete turn. In the case of voltage regulation, the minimum regulation step is therefore limited to the voltage difference between two turns. This is disadvantageous in the case of ribbon windings on the low-voltage side because, owing to the relatively low total number of turns, for example in the region of ten, fine regulation within the range of +/−15%, for example, is not possible in steps of 1.5% around the rated transformation ratio, for example.

Against the background of known implementations, exemplary embodiments of the present disclosure provide a transformer which enables regulation of the voltage on the low-voltage side with relatively small voltage increments, wherein a corresponding on-load tap changer is to be manufactured more easily owing to the then lower voltage loading.

### SUMMARY

An exemplary transformer is disclosed, comprising: a transformer core having at least one core limb, a main winding arranged around a respective core limb in a hollow-cylinder-like winding region, and an auxiliary winding, which is electrically connected to the main winding and is arranged close to the core, wherein the cross-section of at least one of the core limb and a core yoke formed of the transformer core has in a cross-sectional plane transverse to an extent of said core limb or said core yoke, at least two regions which are separated by an aperture, and at least one turn of the respective auxiliary winding is passed through the aperture.

### BRIEF DESCRIPTION OF THE DRAWINGS

The disclosure, further embodiments and further advantages will be described in more detail with reference to the exemplary embodiments illustrated in the drawings, in which:

FIG. 1 shows an exemplary cross-section of a first core limb according to an exemplary embodiment of the present disclosure;

FIG. 2 shows an exemplary cross-section of a second core limb according to an exemplary embodiment of the present disclosure;

FIG. 3 shows an exemplary first transformer core according to an exemplary embodiment of the present disclosure;

FIG. 4 shows an exemplary second transformer core according to an exemplary embodiment of the present disclosure;

FIG. 5 shows an exemplary transformer according to an exemplary embodiment of the present disclosure; and

FIG. 6 shoes an exemplary series circuit including main and auxiliary windings according to an exemplary embodiment of the present disclosure.

### DETAILED DESCRIPTION

Exemplary embodiments of the present disclosure provides a transformer of the type mentioned at the outset. The transformer is including of the fact that the cross-section of the core limb and/or of a core yoke formed of the transformer core has, in an imaginary cross-sectional plane transverse to the respective extent (e.g., length) of the core limb or the core yoke, at least two regions which are separated by an aperture, and at least one turn of the respective auxiliary winding is passed through the aperture.

According to exemplary embodiments of the present disclosure includes the induced voltage of a complete turn, which, for regulation purposes, is intended to be reduced by virtue of the fact that the turn does not surround the cross-section of the complete core limb or of a core yoke of the transformer core, but only part of the cross-section. As a result, only some of the flux is encompassed by the core limb or by the core yoke as well and the voltage induced in such a turn is correspondingly reduced. For this purpose, provision is made according to the disclosure for the core limb cross-section or the core yoke cross-section to have, in an imaginary cross-sectional plane transverse to the respective extent (e.g., length, circumference), at least two regions which are separated from one another by an aperture. The extent is understood to be in the longitudinal direction of a respective limb or yoke section. The angle within the cross-sectional plane at which an aperture runs is in principle inconsequential, and the manufacturing-related boundary conditions can be key. This aperture makes it possible to pass through one or else more turns of the auxiliary winding, whereby the voltage step of the respective turn is reduced. As a result, finer grading of the voltage of the auxiliary winding is advantageously achieved.

An aperture can be realized, for example, by a bore, which is passed through the core limb or the core yoke. In the case of a laminated transformer core, likewise a channel-like aperture for a round conductor, for example, can be provided by corresponding cutouts in a lamination layer region. Corresponding to a further configuration of the present disclosure, the aperture is in the form of a gap, which extends along the core limb. Such a gap can be realized particularly easily depending on the transformer core type.

Exemplary embodiments of the present disclosure can provide a correspondingly higher number of gaps and therefore also of cross-section regions. The subdivision can in principle be as desired in order to meet the conditions for controllability, for example for ⅓ or ¼. Specific voltage steps can also be realized, however, by a plurality of turns being laid around part of the limb, for example 3 turns around ¼ of the core limb cross-section, 4 turns around ⅕ of the core limb cross-section or 9 turns around 1/10 of the core limb cross-section. If the windings are laid separately around part of the core limb cross-section, the wiring can be used, by virtue of the selection of the winding sense or the polarity of the (auxiliary) turn, to allow the wiring to act either additively or subtractively. It is therefore possible to reduce the number of (auxiliary) turns specified for voltage controllability.

This will be explained using the example of 4 (auxiliary) turns around ⅕ of the core limb cross-section. Without any change in polarity, an adjustable turn's number results as follows:

1,=1

1+⅕=1.2,

1+⅖=1.4,

1+⅗=1.6,

2+⅘=1.8,

2=2.

For a control range that goes beyond this arrangement and according to another exemplary embodiment is possible to use taps of turns of the auxiliary winding which encompass the entire core limb cross-section. Thus, the turns passed through a respective gap are ultimately used exclusively for fine regulation steps.

With a change in polarity, the following example results in the case of 2 (auxiliary) turns around ⅕ of the core limb cross-section taking into consideration a change in polarity:

1,=1,

1+⅕=1.2,

1+⅖=1.4,

1−⅖=1.6,

2−⅕=1.8,

2=2.

However, according to another exemplary embodiment, at the same time, (auxiliary) turns which encompass parts of the core limb cross-section of different sizes, for example ½ and ¼, can be provided. For example, the voltage can be regulated in +/−25% increments of the voltage of a full turn by virtue of the core limb cross-section area being divided into three regions, whose contents are 50%, 25% and 25% of the total cross-section area. Hereby, +/−25%, +/−50% and +/−75% increments of the full voltage of a turn are achieved.

Corresponding to an exemplary embodiment of the transformer according to the disclosure, at least the auxiliary winding is formed by a flat ribbon conductor, but ideally also the main winding. A flat ribbon conductor is suitable, owing to its high fill factor, in particular for a transformer winding on the low-voltage side, where correspondingly high currents are expected in the case of relatively low rated voltages in the range of from, for example, a few 100 V up to even over 1 kV, which correspondingly high currents can easily exceed 1000 A. Furthermore, a flat ribbon conductor, owing to its manufacture, can also be passed easily through a gap according to the disclosure which separates two core limb regions from one another. Such a flat ribbon conductor can have a width which corresponds to the total axial height of the respective winding and with the result that a conductor layer in each case precisely includes one turn.

For safe electrical insulation of the winding conductor passed through the gap, provision is made according to the disclosure for the winding conductor to be surrounded, at least in the region of the gap, by an additional layer including an electrical insulation material. The gap is formed by the grounded transformer core and is therefore of particular significance in terms of insulation in particular because, depending on the present wiring of the auxiliary winding, the total rated voltage can also be present in the turn(s) passed through the gap. Optionally, however, according to another exemplary embodiment the gap walls can be surrounded by an additional layer of insulation material.

According to an exemplary embodiment of the present disclosure, a transformer can include an auxiliary winding that is provided with a plurality of taps on different turns of the auxiliary winding. Ideally, the auxiliary winding has a fine grading range, which includes taps of turns of the auxiliary winding which are passed through the respective gap of a core limb. These turns each have an induced voltage which is lower than the induced voltage of a turn which completely surrounds the respective core limb. Furthermore, a coarse grading region can be provided, which includes taps of turns which completely surround the core limb in each case. By correspondingly connecting the coarse and fine grading regions in series with one another, fine grading can be achieved over a wide region.

According to another exemplary embodiment of the present disclosure, the transformer can include switching means (e.g., switches) are provided in order to connect the main winding optionally to one of the taps of the auxiliary winding, with the result that the number of active turns of the main winding and auxiliary winding, which are electrically connected, can be adapted based on a selected tap. Possibly, separate switching means are provided for the coarse and fine grading region of the auxiliary winding.

According to an exemplary configuration of the transformer, the switching means can include an on-load tap changer and/or power electronics components. On-load tap changers have proven successful as standard components for the optional selection and wiring of taps of a transformer winding. According to another exemplary embodiment, power electronics components such as thyristors or IGBTs are also provided.

In principle, exemplary embodiments described herein can be applied to any desired transformer core type, in particular also to three-limb cores, five-limb cores or else to a transformer with a triangular outline. These cores can be laminated or else wound, for example. Some particular embodiments will be illustrated in more detail below, however.

According to yet another exemplary embodiment of the present disclosure, the transformer core can be formed from a rectangle-like outer core ring disk and at least two rectangle-like inner core ring disks surrounded thereby, wherein a respective gap is formed in the limb region between adjoining sections of the core ring disks. The basic structure of such a transformer core, apart from the respective gaps, corresponds in principle to the structure of an Evans transformer core. The core ring disks can be manufactured from in each case wound ribbon material. In addition to standard transformer laminations, amorphous ribbon material can also be used for this purpose, for example. However, according to another exemplary embodiment the flat core material to be layered.

According to another exemplary embodiment of the present disclosure, the transformer includes a transformer core formed from three rectangle-like core ring disks arranged in a triangle, wherein a respective gap is formed in the limb region between adjoining sections of the core ring disks. According to another exemplary embodiment to a core ring disk can be wound either from a ribbon-like material or else to layer it from a sheet-like material.

According to an exemplary embodiment of the present disclosure, the transformer includes a transformer core formed as a toroidal core, by which the at least one core limb is formed. The entire toroidal core then should be considered to be a bent transformer core limb, wherein at least two toroidal core modules are provided for forming the gap according to the disclosure which runs along the toroidal core.

According to another exemplary embodiment of the present disclosure, the transformer includes a galvanically isolated further winding is arranged radially around the main winding. In this case, the main winding on the low-voltage side and the further winding on the high-voltage side are interconnected. By virtue of the ratio of the respectively active high-voltage-side and low-voltage-side turns with respect to one another, the transformation ratio of the transformer is determined. This arrangement has a three-phase embodiment in accordance with a further configuration, and is serviceable for use in an energy distribution network.

According to yet another exemplary embodiment of the present disclosure, the transformer includes a main winding, which is arranged around a transformer core limb, and is connected electrically in series with an auxiliary winding, which is arranged around the same core limb. As a result, the phase angle of the voltage induced in the auxiliary winding corresponds to the phase angle of the voltage induced in the main winding, or it is offset through 180° and in phase opposition with corresponding wiring with a change in polarity. As a result, in-phase regulation of the voltage is achieved.

According to an exemplary embodiment of the present disclosure, the transformer includes a main winding, which is arranged around a transformer core limb, and is connected electrically in series with an auxiliary winding, which is arranged around an adjacent transformer core limb. Therefore, in the case of a three-phase transformer, a phase shift of 120° or 240° between the voltages induced in the main winding and the auxiliary winding results. In the case of corresponding wiring with a change in polarity, phase-angle regulation with a 60° angle can be realized.

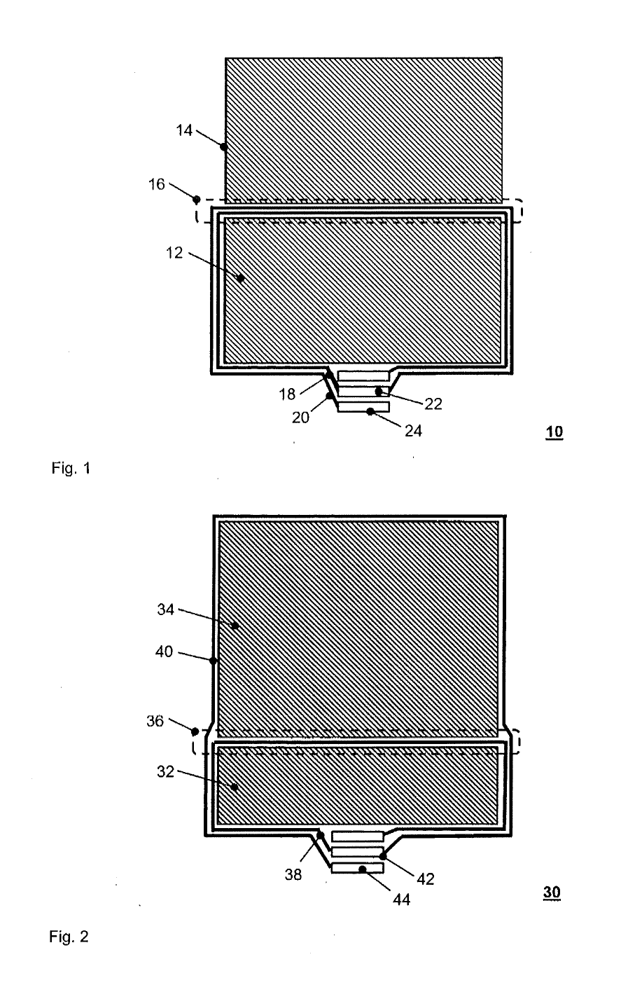

FIG. 1 shows an exemplary cross-section of a first core limb according to an exemplary embodiment of the present disclosure. As shown in FIG. 1 a first core limb 10 is formed by two identical core limb modules, each having the same cross-section regions 12, 14, wherein a gap 16 is developed between the cross-section regions, which gap separates the cross-section regions 12 and 14 from one another. Two exemplary turns 18, 20 of a ribbon conductor which are passed through the gap 16 and are part of an exemplary auxiliary winding are arranged around the first cross-section region 12, which makes up 50% of the total cross-section area of the core limb 10. Because each of the two turns only surrounds 50% of the entire core limb cross-section, correspondingly the voltage induced in a respective turn during operation only amounts to 50% of the voltage of a conductor which encompasses the entire core limb cross-section. In this way, finer voltage grading of the taps is realized, which taps are denoted by the reference symbols 22 and 24. These are intended to be connected to an on-load tap changer (not shown), which for its part is connected to a main winding (not shown).

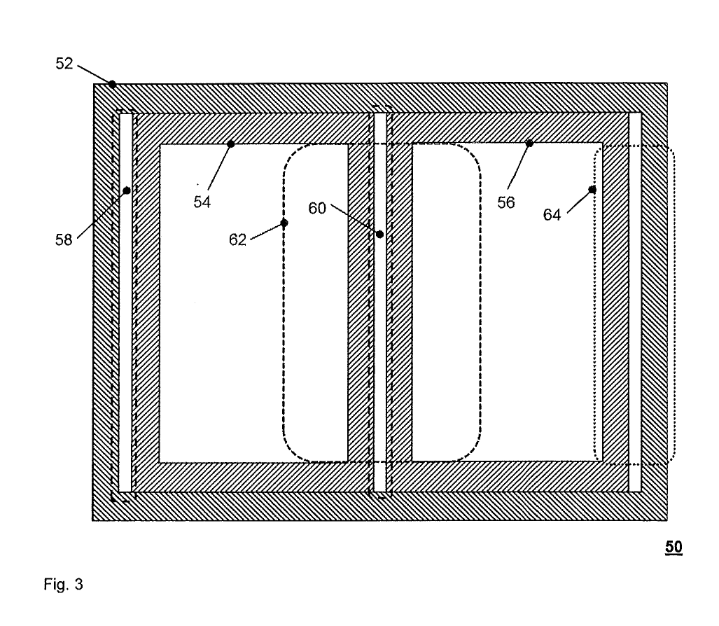

FIG. 2 shows an exemplary cross-section of a second core limb according to an exemplary embodiment of the present disclosure. As shown in FIG. 2, a second core limb 30 is formed by two core limb modules, whose cross-section regions 32 and 34 are divided approximately with a ratio of 1:3. The first cross-section region 32, which makes up approximately 25% of the total core limb cross-section area, is encompassed by a first turn 38 of an auxiliary winding, which first turn is passed through a gap 36, wherein a second turn 40 of the auxiliary winding encompasses the complete core limb cross-section. Correspondingly, the level of the voltage induced in the first turn 38 during operation is 25% of the voltage induced in the second turn 40 during operation. In this way, finer voltage grading of the taps is realized, which taps are identified by the reference symbols 42 and 44. These are intended to be connected to an on-load tap changer (not shown), which for its part is connected to a main winding (not shown).

FIG. 3 shows an exemplary first transformer core according to an exemplary embodiment of the present disclosure. As shown in FIG. 3 shows a first transformer core 50 includes a rectangle-like outer core ring disk 52, for example with a width of 2 m and a height of 1.5 m, surrounds two likewise rectangle-like inner core ring disks 54, 56, with the result that a transformer core with three core limbs 64 is formed, wherein each core limb 64 for its part is formed from two adjoining limb sections of respective core ring disks. A respective gap 58 is developed between the limb sections and is intended to have one or more winding conductors of an auxiliary winding (not shown) which is arranged radially on the inside around the respective core limb passed through the gap. Such a gap 58 can be realized very easily by virtue of the fact that the sum of the outer width of the inner core ring disks is less than the inner width of the outer core ring disk encompassing the inner core ring disks. Core ring disks can be manufactured, for example, from wound ribbon material or else from a laminated metal sheet,

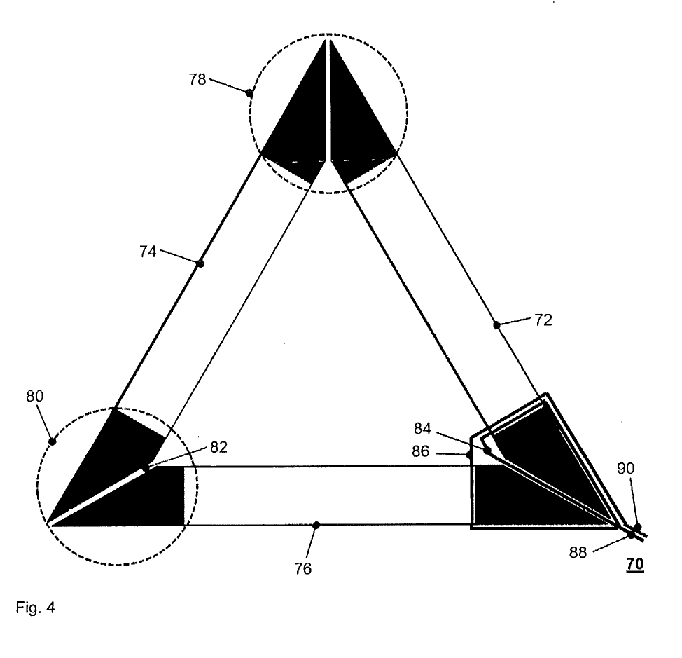

FIG. 4 shows an exemplary second transformer core according to an exemplary embodiment of the present disclosure. As shown in FIG. 4, a second transformer core 70 includes three rectangle-like core ring disks 72, 74, 76 that are arranged adjacent to one another in an equilateral triangle, wherein mutually adjoining limb sections form a respective core limb 78, 80 with a respective gap 82 therebetween. An exemplary first turn 84 of an auxiliary winding is passed around one of the two limb sections of a core limb 78, 80 and through a gap positioned therebetween, which first turn 84 encompasses 50% of the cross-section area of the corresponding core limb and into which a correspondingly reduced voltage is induced during operation. A second exemplary turn 86 of the auxiliary winding encompasses the entire cross-section area of the same core limb. The auxiliary winding is connectable to an on-load tap changer (not shown) of a main winding (not shown) by the connections 88, 90, for example.

FIG. 5 shows an exemplary transformer according to an exemplary embodiment of the present disclosure. As shown in FIG. 5, an exemplary transformer 100 is in the form of a toroidal core transformer. The ring-like transformer core can have a ring-like radially outer first part 102 and a ring-like radially inner part 104, wherein a gap is developed therebetween. According to another exemplary embodiment, the transformer core can be configured to be not precisely circular (e.g., approximately or substantially circular), but polygonal, for example. Two exemplary main windings 106a,b and two exemplary auxiliary windings 108a,b are provided along the ring-like extent (e.g., length, circumference) of the transformer core so as to encompass the transformer core and (not illustrated) are interconnected to form a low-voltage-side winding. According to an exemplary embodiment, the auxiliary windings 108a,b can encompass part of the core cross-section exclusively (e.g., only) and a correspondingly lower voltage per turn is induced during operation. In combination with corresponding taps and with an on-load tap changer, for example, a fine regulation possibility for the low-voltage-side winding results. Two further galvanically isolated windings 107a,b, which are interconnected to form a high-voltage winding, are likewise arranged on the toroidal core.

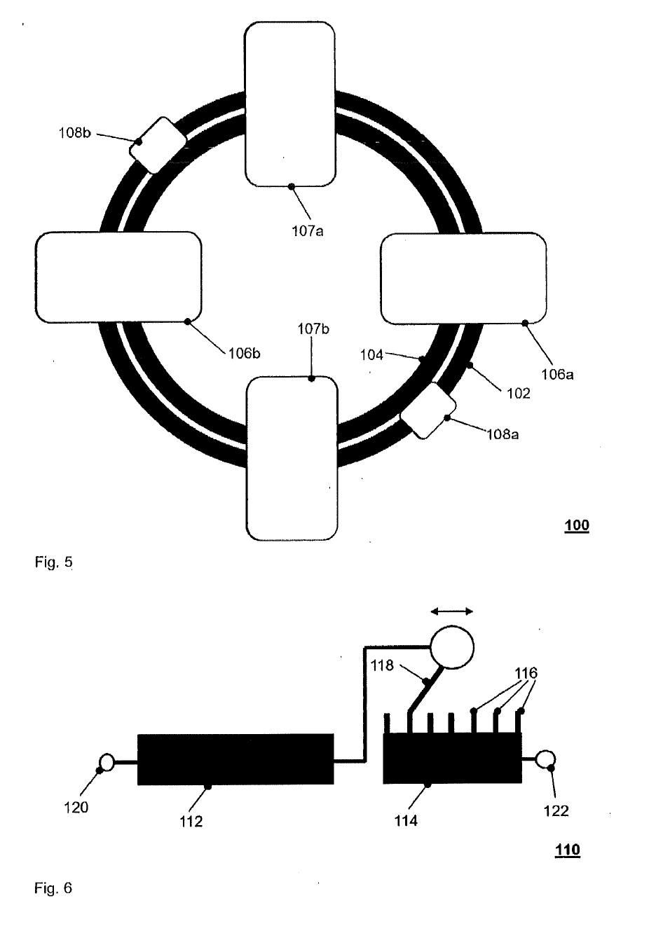

FIG. 6 shoes an exemplary series circuit including main and auxiliary windings according to an exemplary embodiment of the present disclosure. As shown in FIG. 6, an exemplary series circuit includes a main winding 112 and an auxiliary winding 114 to form a low-voltage-side winding with respective connections 120, 122. The auxiliary winding can have a plurality of taps 116, wherein in each case one turn which, according to the disclosure, is passed through a gap in an associated transformer core (not illustrated) is arranged between adjacent taps, which turn encompasses in each case ⅙ of a respective core limb cross-section, for example. An on-load tap changer 118 can be provided for producing an electrical contact with a respectively selected tap 116 and for producing a series circuit including the main winding 112 and the corresponding part of the auxiliary winding 114.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

10 exemplary cross-section of a first core limb
12 first region of the cross-section of the first core limb
14 second region of the cross-section of the first core limb
16 first gap
18 first turn of the auxiliary winding around first core limb
20 second turn of the auxiliary winding around first core limb
22 first tap of the auxiliary winding around first core limb
24 second tap of the auxiliary winding around first core limb
30 exemplary cross-section of a second core limb
32 first region of the cross-section of the second core limb
34 second region of the cross-section of the second core limb
36 second gap
38 first turn of the auxiliary winding around second core limb
40 second turn of the auxiliary winding around second core limb
42 first tap of the auxiliary winding around second core limb
44 second tap of the auxiliary winding around second core limb
50 exemplary first transformer core
52 outer core ring disk
54 first inner core ring disk
56 second inner core ring disk
58 third gap
60 fourth gap
62 hollow-cylinder-like winding region
64 third core limb
70 exemplary second transformer core
72 first core ring disk
74 second core ring disk
76 third core ring disk
78 fourth core limb
80 fifth core limb
82 fifth gap
84 first turn of the auxiliary winding
86 second turn of auxiliary winding
88 first connection of auxiliary winding
90 second connection of auxiliary winding
100 exemplary transformer
102 first part of the transformer core
104 second part of the transformer core
106a,b main winding
107a,b galvanically isolated further winding
108a,b auxiliary winding
110 exemplary series circuit including main and auxiliary winding
112 main winding
114 auxiliary winding
116 taps
118 on-load tap changer
120 first connection
122 second connection

What is claimed is:

1. A transformer, comprising:
a transformer core having at least one core limb, a main winding arranged around a respective core limb in a hollow-cylinder-like winding region, and an auxiliary winding, which is electrically connected to the main winding and is arranged close to the core,
wherein the cross-section of at least one of the core limb and a core yoke formed of the transformer core has in a cross-sectional plane transverse to an extent of said core limb or said core yoke, at least two regions which are separated by an aperture, and at least one turn of the respective auxiliary winding is passed through the aperture.

2. The transformer as claimed in claim 1, wherein the aperture is a gap which extends along the core limb.

3. The transformer as claimed in claim 2, wherein at least the auxiliary winding is formed by a flat ribbon conductor.

4. The transformer as claimed in claim 3, wherein the flat ribbon conductor is surrounded by an additional layer consisting of an electric insulation material, at least in the region of the aperture.

5. The transformer as claimed in claim 1, wherein the auxiliary winding is provided with a plurality of taps on different turns of the auxiliary winding.

6. The transformer as claimed in claim 4, wherein switching means are provided in order to connect the main winding selectively to one of the taps, such that a number of active turns of the main winding and auxiliary winding, which are electrically connected, can be adapted based on a selected tap.

7. The transformer as claimed in claim 6, wherein the switching means include at least one of an on-load tap changer and power electronics components.

8. The transformer as claimed in claim 1, wherein the transformer core is formed from a rectangle-like outer core ring disk and at least two rectangle-like inner core ring disks surrounded thereby, wherein a respective gap is formed in the limb region between adjoining sections of the core ring disks.

9. The transformer as claimed in one of claim 1, wherein the transformer core is formed from three rectangle-like core ring disks arranged in a triangle, wherein a respective gap is formed in the limb region between adjoining sections of the core ring disks.

10. The transformer as claimed in one of claim 1, wherein the transformer core is a toroidal core, by which the at least one core limb is formed.

11. The transformer as claimed in claim 1, wherein a galvanically isolated further winding is arranged radially around the main winding.

12. The transformer as claimed in claim 11, wherein said transformer has a three-phase embodiment.

13. The transformer as claimed in claim 12, wherein the main winding, which is arranged around a transformer core limb, is connected electrically in series with an auxiliary winding, which is arranged around the same core limb.

14. The transformer as claimed in claim 12, wherein the main winding, which is arranged around a transformer core limb, is connected electrically in series with an auxiliary winding, which is arranged around an adjacent transformer core limb.
